(19) United States
(12) Patent Application Publication
(10) Pub. No.: US 2021/0237196 A1
(43) Pub. Date: Aug. 5, 2021

(54) MANUFACTURING METHOD OF THIN PLATE

(71) Applicant: A.F.W. Co., Ltd., Chilgok-gun (KR)

(72) Inventors: KI YOUNG KIM, Daegu (KR); MYEONG HUN KIM, Gumi-si (KR)

(21) Appl. No.: 16/911,408

(22) Filed: Jun. 25, 2020

(30) Foreign Application Priority Data
Jan. 30, 2020 (KR) 10-2020-0011043

(51) Int. Cl. B23K 20/12; B21D 39/03

(52) U.S. Cl. CPC B23K 20/12; B23K 2103/10; B21D 39/03

(57) ABSTRACT

According to an embodiment, a method for manufacturing a thin plate comprises placing a copper piece on a side of an aluminum piece, forming a heterogeneous metal joined body by performing friction welding on the side of the aluminum piece and a side of the copper piece to thereby form a spread layer of the aluminum piece on the side of the aluminum piece, and a spread layer of the copper piece on the side of the copper piece, the respective spread layers of the aluminum piece and the copper piece being mixed into a mixed layer that is then cured, and forming the thin plate by roll-milling the heterogeneous metal joined body.

### CROSS-REFERENCE TO RELATED APPLICATION(S)

This application is based on and claims priority under 35 U.S.C. 119 to Korean Patent Application No. 10-2020-0011043, filed on Jan. 30, 2020, in the Korean Intellectual Property Office, the disclosure of which is herein incorporated by reference in its entirety.

### TECHNICAL FIELD

Embodiments of the disclosure relate to a method for manufacturing a thin plate, and more specifically, to a method for manufacturing a thin plate by forming a heterogeneous metal joined body using friction welding on aluminum and copper and then roll-milling the heterogeneous metal joined body.

### DESCRIPTION OF RELATED ART

A thin plate refers to a thin steel plate which is typically about 3 mm or less thick and is used for bus bars or polymer batteries.

Korean Patent No. 10-1768799 issued on Aug. 9, 2017 discloses a copper/iron-nickel alloy joined thin plate formed by electrodeposition and a method for manufacturing the same. The method includes the steps of preparing a Cu thin plate and forming a joined thin plate by electrodepositing a Fe—Ni alloy onto the Cu thin plate. The electrolyte used in the electrodeposition contains, relative to one part by weight of iron sulfate(FeSO4.7H2O), 0.49 to 0.94 parts by weight of sulfur nickel(NiSO4.6H2O), 0.20 to 0.31 parts by weight of boric acid(H3BO3), 0.009 to 0.044 parts by weight of sodium saccharine(C7H4NO3SNa), 0.0009 to 0.0033 parts by weight of sodium lauryl sulfate(C12H25O4SNa), and 0.23 to 0.37 parts by weight of sodium chloride(NaCl). The joined thin plate is formed in a thickness ranging from 15 μm to 25 μm. In the electrodeposition step, a copper (Cu) thin plate is used as the cathode, and a nickel (Ni) plate is used as the anode. The temperature of the electrolyte ranges from 50° C. to 70° C., pH from 0.5 to 2.0, and the current density from 5 mA/cm² to 30 mA/cm². The joined thin plate has a thermal expansion coefficient ranging from 6.35(10⁻⁶/° C.) to 7.10(10⁻⁶/° C.).

Korean Patent No. 10-1550044 issued on Aug. 28, 2015 discloses a thin plate, a method for manufacturing the thin plate, and a metal capacitor using the same. The method disclosed in Korean Patent No. 10-1550044 includes the steps of preparing a metal member, forming a plurality of through holes penetrating the metal member from the top to bottom or a plurality of holes arranged in one or more of the top and bottom, and forming an alloy layer of a predetermined thickness along the overall surface of the metal member using electroless plating. In the step of forming the alloy metal, electroless plating uses a plating agent that contains 1 wt % to 70 wt % of main component, 2 wt % to 80 wt % of sub component, 2 wt % to 60 wt % of complexing agent, and 5 wt % to 50 wt % of reducing agent. As the main component, a metal or metal hydrate is used and, as the sub component, either Na₂WO₄.2H₂O or MnSO₄.H₂O is selectively used. As the complexing agent, one of sodium malonate, ammonium citrate, sodium citrate, sodium gluconate, ammonium gluconate, ammonium adipate, sodium adipate, ammonium acetate, sodium acetate, ammonium lactate, sodium lactate, ammonium succinate, and sodium succinate is selectively used, and as the reducing agent, sodium hypophosphite is used.

As described above, the conventional thin plate is formed typically by plating a copper sheet with nickel. However, copper is expensive and heavy and may leave poor durability issues on the final product.

### SUMMARY

To address the foregoing issues, according to an embodiment, there is provided a method for manufacturing a thin plate by forming a heterogeneous metal joined body using friction welding on aluminum and copper and then roll-milling the heterogeneous metal joined body.

According to an embodiment, a method for manufacturing a thin plate comprises placing a copper piece on a side of an aluminum piece, forming a heterogeneous metal joined body by performing friction welding on the side of the aluminum piece and a side of the copper piece to thereby form a spread layer of the aluminum piece on the side of the aluminum piece, and a spread layer of the copper piece on the side of the copper piece, the respective spread layers of the aluminum piece and the copper piece being mixed into a mixed layer that is then cured, and forming the thin plate by roll-milling the heterogeneous metal joined body.

In forming the heterogeneous metal joined body, the aluminum piece and the copper piece each may be mounted on a friction welder or equipment and are rotated to join together, in opposite directions from each other, at a rotational speed ranging from 1,600 revolutions per minute (rpm) to 2,200 rpm while applying a pressurization force ranging from 7 tons to 20 tons to a contact surface between the aluminum piece and the copper piece.

In forming the thin plate, the heterogeneous metal joined body may be inserted into a rolling mill or equipment to be roll-milled in a lengthwise or widthwise direction thereof.

In forming the thin plate, the heterogeneous metal joined body may be roll-milled to a preset thickness.

The method may further comprise, after forming the thin plate, cutting the thin plate to a preset length.

According to an embodiment, a heterogeneous metal joined body is formed by frictional-welding an aluminum sheet and a copper sheet and the heterogeneous metal joined body is then roll-milled into a thin plate. Thus, it is possible to achieve an increased aluminum-copper joining strength, a reduction in weight, and cost savings.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flowchart illustrating a method for manufacturing a thin plate according to an embodiment;

FIG. 2 is a view illustrating the step of forming a heterogeneous metal joined body as shown in FIG. 1;

FIG. 3 is a view illustrating the step of forming a thin plate as shown in FIG. 1; and

FIG. 4 is a flowchart illustrating a method for manufacturing a thin plate according to an embodiment.

### DETAILED DESCRIPTION OF EXEMPLARY EMBODIMENTS

Embodiments of the present disclosure are now described with reference to the accompanying drawings in such a detailed manner as to be easily practiced by one of ordinary skill in the art. However, the embodiments set forth herein are provided merely for a better understanding of the structure and functions, and the scope of the disclosure should not be limited thereby or thereto. Thus, various changes or modifications may be made to the embodiments and various equivalents thereof may be included in the scope of the disclosure. It should be noted that a specific embodiment of the disclosure need not include all of the objectives or effects set forth herein and the scope of the disclosure should not be limited thereto or thereby.

The terms as used herein may be defined as follows.

The terms “first” and “second” are used to distinguish one component from another, and the scope of the disclosure should not be limited thereby. For example, a first component may be denoted a second component, and vice versa without departing from the scope of the present disclosure.

When a component is “connected to” or “coupled to” another component, the component may be directly connected or coupled to the other component, or other component(s) may intervene therebetween. In contrast, when a component is “directly connected to” or “directly coupled to” another component, no other intervening components may intervene therebetween. Other terms or phrases representing the relationship between two or more components, such as ‘between’ and ‘adjacent to,’ may be interpreted the same way.

IAs used herein, the singular forms “a,” “an,” and “the” are intended to include the plural forms as well, unless the context clearly indicates otherwise. It will be further understood that the terms “comprise” and/or “have,” when used in this specification, specify the presence of stated features, integers, steps, operations, elements, and/or components, but do not preclude the presence or addition of one or more other features, integers, steps, operations, elements, components, and/or groups thereof.

Unless otherwise defined in connection with embodiments of the present disclosure, all terms including technical and scientific terms used herein have the same meaning as commonly understood by one of ordinary skill in the art to which the embodiments of the present disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A method for manufacturing a thin plate, according to an embodiment, is described below in detail with reference to the accompanying drawings.

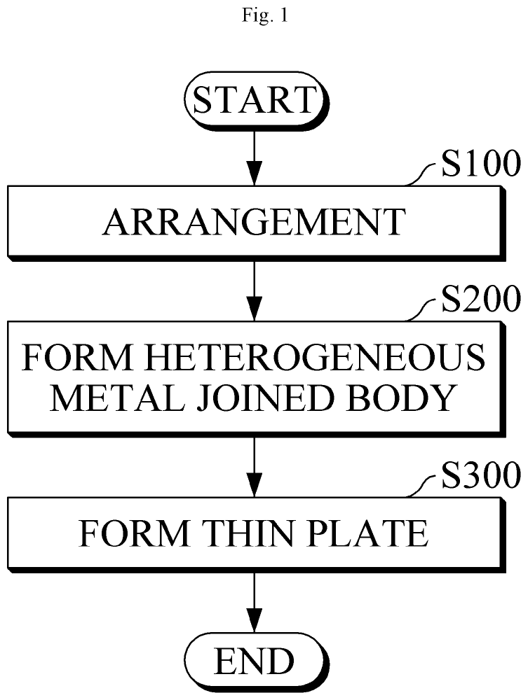

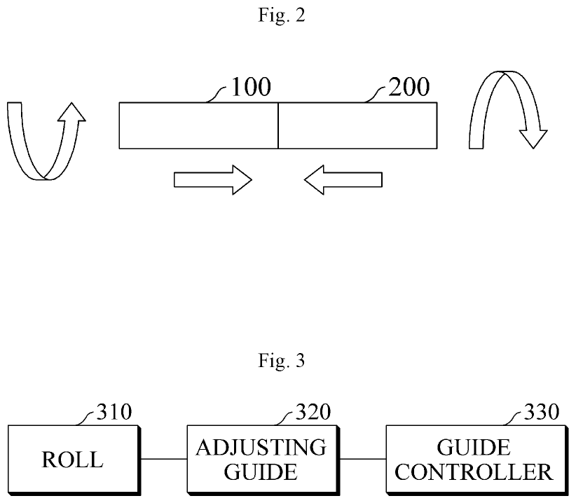

FIG. 1 is a flowchart illustrating a method for manufacturing a thin plate according to an embodiment. FIG. 2 is a view illustrating the step of forming a heterogeneous metal joined body as shown in FIG. 1. FIG. 3 is a view illustrating the step of forming a thin plate as shown in FIG. 1.

Referring to FIGS. 1 to 3, a method for manufacturing a thin plate includes arranging (S100), forming a heterogeneous metal joined body (S200), and forming a thin plate (S300).

In S100, a copper (Cu) piece 200 is placed on a side of a aluminum (Al) piece 100.

In S100, the Al piece 100 and the Cu piece 200 may be shaped as a pillar, bar, or pole, but the Cu piece 200 and the Al piece 100 may be prepared in other various shapes or sizes.

In S100, one side of the Cu piece 200 may be brought in tight contact with one side of the Al piece 100 by use of a friction welder or other equipment.

In S200, a heterogeneous metal joined body is formed by friction-welding between the side of the Cu piece 200 and the side of the Al piece 100. By the friction welding, the side of the Al piece 100 is plastically deformed to form a spread layer, and the side of the Cu piece 200 is plastically deformed to form a spread layer. The spread layer of the Al piece 100 and the spread layer of the Cu piece 200 are mixed into a mixed layer which is then cured.

In other words, in S200, the solid-state spread layer of the Al piece 100 and the solid-state spread layer of the Cu piece 200 are formed by frictional heat and are mixed together into a mixed layer. The mixed layer is cured or hardened.

Friction welding refers to a way of welding by generating frictional heat at a temperature ranging from 1,000° C. to 1,400° C. on the contact surface by pressurizing a side surface of a stationary material in a range from 3 tons-10 tons while rotating another material in a range from 1,600 rpm to 2,200 rpm and then stopping the rotating material while re-pressurizing to the contact surface in a range from 7 tons to 20 tons to thereby plastically deform it.

In S200, the Al piece 100 and the Cu piece 200 each are mounted on a friction welder or equipment and, as shown in FIG. 2, the Al piece 100 and the Cu piece 200 are rotated in opposite directions and are joined together by the frictional heat generated from the contact surface between the Al piece 100 and the Cu piece 200. The relative rotational speed of the Al piece 100 or the Cu piece 200 may be increased up to the sum of the respective RPMs of the Al piece 100 and the Cu piece 200. Despite no external braking force, the rotation of the Al piece 100 and the Cu piece 200 may be put on brake as the force of the Al piece 100 rotating in one direction and the force of the Cu piece 200 rotating in the opposite direction are canceled off each other on the contact surface.

In S200, each of the Al piece 100 and the Cu piece 200 mounted on a friction welder or equipment may be rotated at a speed ranging from 1,600 rpm to 2,200 rpm, in one direction for the Al piece 100 and in the opposite direction for the Cu piece 200, with the Al piece 100 and the Cu piece 200 in tight contact with each other, while pressurizing to the contact surface in a force ranging from 7 tons to 20 tons.

In S200, spread layers form on the respective side surfaces of the Al piece 100 and the Cu piece 200, and the spread layers are mixed together into a mixed layer. The mixed layer is hardened or cured, thereby forming a heterogeneous metal joined body secure and durable enough to be prevented from defects or cracks although subjected to roll-milling.

In S200, beads building up during friction welding may be removed by a bead remover. Thus, after the surface of the heterogeneous metal joined body is made flat, smooth, or seamless, the heterogeneous metal joined body may go through roll-milling. By so doing, any defects may be reduced.

In S300, a rolling mill or equipment is used to roll the heterogeneous metal joined body formed in S200 into a thin plate.

In S300, the roll-milling may increase the crude density of the mixed layer and hence the adhesivity or strength between the Al piece 100 and the Cu piece 200.

In S300, the heterogeneous metal joined body may be inserted into a rolling mill or equipment to be roll-milled in the lengthwise or widthwise direction of the heterogeneous metal joined body.

In S300, the width of the heterogeneous metal joined body may range from 1 mm to 10 mm.

In S300, the heterogeneous metal joined body may be roll-milled in its lengthwise or widthwise direction into a thin plate of a desired shape or size. Thereby, various products may be implemented.

In S300, the heterogeneous metal joined body may be roll-milled in a preset thickness (e.g., in a range from 50 μm to 50,000 μm) depending on uses, by adjusting the interval between the rolls of the rolling mill or equipment.

In S300, the rolling mill or equipment may include a plurality of rolls 310, a plurality of adjusting guides 320, and a plurality of guide controllers 330 as shown in FIG. 3.

The rolls 310 may perform roll-milling on the heterogeneous metal joined body in the lengthwise or widthwise direction, with the width or length adjusted by the adjusting guides 320.

The adjusting guides 320 may be installed on both sides of the rolls 310 and tight-contactingly move to the rolls 310 under the control of the guide controllers 330 to thereby adjusting the width or length of the heterogeneous metal joined body.

According to an embodiment, the adjusting guides 320 may be guide lines or guide plates.

The guide controllers 330 may control the adjusting guides 320 to tight-contactingly move from both sides of the rolls 310 to the rolls 310, corresponding to a preset width or length of the heterogeneous metal joined body.

According to an embodiment, the guide controllers 330 may include a hydraulic or pneumatic cylinder and may move the guide lines or guide plates using the hydraulic or pneumatic cylinder.

The above-described method for manufacturing a thin plate may perform friction welding on the Al piece 100 and the Cu piece 200 under preset RPM and pressurization force conditions to thereby form a heterogeneous metal joined body with a mixed layer of the respective spread layers of the Cu piece 200 and the Al piece 100 and roll-milling on the heterogeneous metal joined body, thereby forming a thin plate. Thus, the joining strength between the Al piece 100 and the Cu piece 200 may be maximized, and the weight and costs may be significantly reduced.

FIG. 2 is a flowchart illustrating a method for manufacturing a thin plate according to an embodiment.

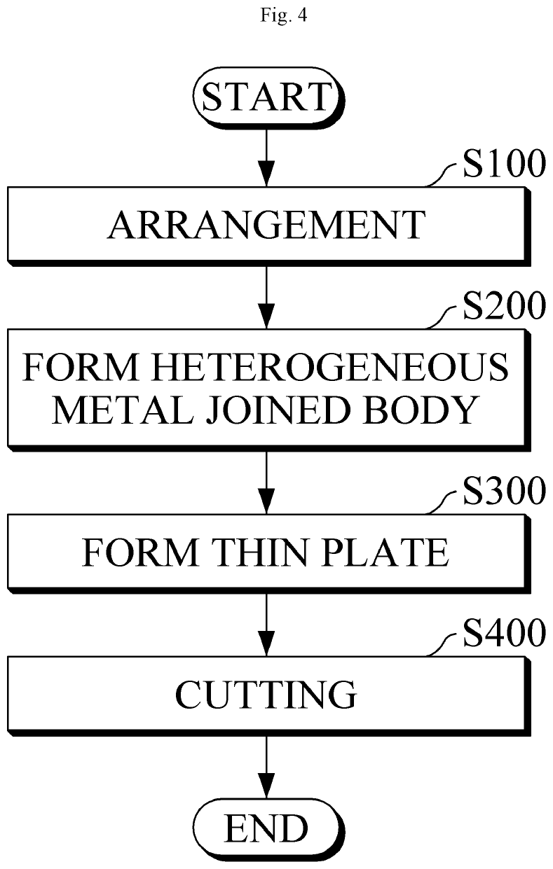

Referring to FIG. 4, after S300, the thin plate may be cut to a preset length (e.g., 5 mm to 500 mm) depending on the use (S400).

In S400, the thin plate may be cut by a cutter to various lengths or widths as necessary.

The embodiments of the disclosure may be implemented by a program or application for implementing the functions of the components of the embodiments, as well as by the above-described apparatus and/or methods, or may also be implemented by a recording medium storing the program. Such implementation may be readily made by one of ordinary skilled in the art from the foregoing description of the embodiments.

While the disclosure has been shown and described with reference to exemplary embodiments thereof, it will be apparent to those of ordinary skill in the art that various changes in form and detail may be made thereto without departing from the spirit and scope of the disclosure as defined by the following claims.

What is claimed is:

1. A method for manufacturing a thin plate, the method comprising:
placing a copper piece on a side of an aluminum piece;
forming a heterogeneous metal joined body by performing friction welding on the side of the aluminum piece and a side of the copper piece to thereby form a spread layer of the aluminum piece on the side of the aluminum piece, and a spread layer of the copper piece on the side of the copper piece, the respective spread layers of the aluminum piece and the copper piece being mixed into a mixed layer that is then cured; and
forming the thin plate by roll-milling the heterogeneous metal joined body.

2. The method of claim 1, wherein in forming the heterogeneous metal joined body, the aluminum piece and the copper piece each are mounted on a friction welder or equipment and are rotated to join together, in opposite directions from each other, at a rotational speed ranging from 1,600 revolutions per minute (rpm) to 2,200 rpm while applying a pressurization force ranging from 7 tons to 20 tons to a contact surface between the aluminum piece and the copper piece.

3. The method of claim 1, wherein in forming the thin plate, the heterogeneous metal joined body is inserted into a rolling mill or equipment to be roll-milled in a lengthwise or widthwise direction thereof.

4. The method of claim 1, wherein in forming the thin plate, the heterogeneous metal joined body is roll-milled to a preset thickness.

5. The method of claim 1, further comprising, after forming the thin plate, cutting the thin plate to a preset length.
